(19) United States
(12) Patent Application Publication
(10) Pub. No.: US 2010/0241622 A1
(43) Pub. Date: Sep. 23, 2010

(54) METHOD AND APPARATUS FOR QUERY PROCESSING

(76) Inventors: Hee Gyu JIN, Suwon-si (KR); Kyoung Gu Woo, Seoul (KR); Kyuseok Shim, Seoul (KR); Hyoungmin Park, Seoul (KR); Younghoon Kim, Seoul (KR)

Correspondence Address: North Star Intellectual Property Law, PC, P.O. Box 34688, Washington, DC, 20043, US

(21) Appl. No.: 12/699,122

(22) Filed: Feb. 3, 2010

(30) Foreign Application Priority Data
Mar. 20, 2009 (KR) 10-2009-0023910

(51) Int. Cl. G06F 7/10; G06F 17/30

(52) U.S. Cl. 707/719; 707/769; 707/E17.017

(57) ABSTRACT

An n-gram based query processing apparatus and method are provided. A query processing is performed using only a portion of n-grams out of all n-grams with respect to the search key. A candidate set of documents having a possibility of including the search key is extracted using a posting list with respect to the portion of n-grams.

### CROSS-REFERENCE TO RELATED APPLICATION

This application claims the benefit under 35 U.S.C. §119(a) of a Korean Patent Application No. 10-2009-0023910, filed on Mar. 20, 2009, in the Korean Intellectual Property Office, the entire disclosure of which is incorporated herein by reference for all purposes.

### BACKGROUND

1. Field

The following description relates to a query processing apparatus and a method thereof. More particularly, the description relates to an n-gram based query processing apparatus and method applicable to a search an n-gram based index.

2. Description of Related Art

FIG. 1 illustrates a configuration of a conventional n-gram index. Referring to FIG. 1, an “n-gram based index” or an “n-gram index” is constituted by an index tree 110 and posting list 120 corresponding to each of the n-grams. The index tree 110 may be, for example, a B⁺ tree, a hash, and the like. The posting list indicates a list of posts and a post is the location information where an n-gram exists.

The n-gram index may include the posting list 120 corresponding to an n-gram in a leaf node of the index tree 110. The same n-gram may exist in various documents, and the same n-gram may exist in various locations in a single document. Accordingly, the posting list may be in a form of, for example, [document ID, position] to discriminate location information of an n-gram. The “document ID” is identification information of a document and “position” is location information where the n-gram exists in the document.

A method of searching for a search key desired by a user from the n-gram index includes dividing the search key into a plurality of n-grams, searching all the posting-list of each of the plurality of n-grams. This method, however, increases the computer processing time because the length of a search key gets longer, and the number of n-grams increases. Thus, query processing performance is deteriorated.

### SUMMARY

In one general aspect, there is provided a method of processing a search key, the method including selecting a portion of n-grams from all n-grams with respect to the search key, based on a query processing cost, extracting a candidate set of documents having a possibility of including the search key, based on a posting list with respect to the portion of n-grams, and determining a document where the search key exists, based on the candidate set.

The query processing cost may be determined based on a number of accesses that occur to pages of the document, during a query processing procedure.

The query processing cost may be determined based on a cost expended for extracting the candidate set and a cost expended for determining the document including the search key, based on the candidate set.

The cost expended for extracting the candidate set may be determined based on a cost expended for searching from a root node to a leaf node including an n-gram, and based on a number of all leaf nodes including n-grams.

The cost expended for determining the document may be determined based on a number of pages including n-grams among all pages constituting the document.

The selecting of the portion of n-grams may include dividing the search key into a plurality of n-grams, counting a number of posting lists with respect to each of the plurality of n-grams, calculating a query processing cost with respect to each of the plurality of n-grams, and selecting an n-gram subset that has a minimum query processing cost.

The selecting of the n-gram subset may be determined based on an n-gram that has a smallest number of posting-lists and an n-gram that expends a minimum query processing cost.

The extracting of the candidate set may include extracting a posting list of n-grams constituting the portion of n-grams, determining posts located in adjacent positions based on the extracted posting list, extracting document identification information of the documents from the posts located in adjacent positions, and constructing the candidate set based on the extracted document identification information of the documents.

The determining of the document where the search key exists, may include comparing the search key with an actual document corresponding to the candidate set, and selecting document identification information of the document where the search key exists, from among the candidate set.

In another general aspect, there is provided a computer readable storage medium storing one or more executable instructions to cause a processor to perform a method including selecting a portion of n-grams from all n-grams with respect to the search key, based on a query processing cost, extracting a candidate set of documents having a possibility of including the search key, based on a posting list with respect to the portion of n-grams, and determining a document where the search key exists, based on the candidate set.

In another general aspect, there is provided an apparatus for processing a search key based on controlling of a query processing processor, wherein the query processing processor performs selecting of a portion of n-grams from all n-grams with respect to the search key, based on a query processing cost, extracting of a candidate set of documents having a possibility of including the search key, based on a posting list with respect to the portion of n-grams, and determining of a document where the search key exists based on the candidate set.

The apparatus may further include a query processing cost calculator to calculate the query processing cost based on a cost expended for extracting the candidate set and a cost expended for determining the document where the search key exists, based on the candidate set.

The cost expended for extracting the candidate set may be determined based on a cost expended for searching from a root node to a leaf node including an n-gram, and based on a number of all leaf nodes including n-grams.

The cost expended for determining the document may be determined based on a number of pages including n-grams among all pages constituting the document.

An n-gram subset having a minimum query processing cost may be determined as the portion of n-grams.

The apparatus may further include an n-gram index management unit to store and manage an n-gram index to process the search key, and a document database to store the document including the search key. Other features and aspects will be apparent from the following detailed description, the drawings, and the claims.

### BRIEF DESCRIPTION OF THE DRAWINGS

FIG. 1 illustrates a configuration of a conventional n-gram index.

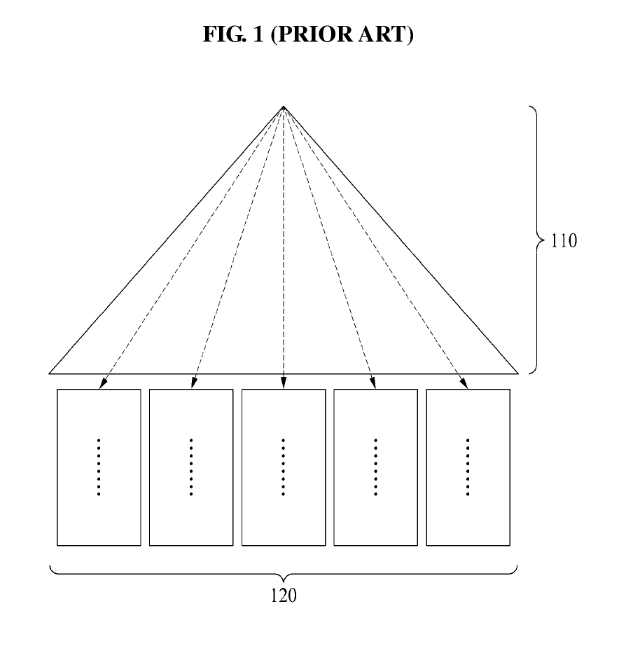

FIG. 2 is a diagram illustrating an example of a fundamental principle.

FIG. 3 is a diagram illustrating an example of a query processing method.

FIG. 4 is a diagram illustrating an example of an n-gram subset selecting method.

FIG. 5 is a diagram illustrating an example of a candidate set selecting method.

FIG. 6 is a diagram illustrating an example of candidate set selecting method.

FIG. 7 is a diagram illustrating an example of a query processing apparatus. Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following detailed description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

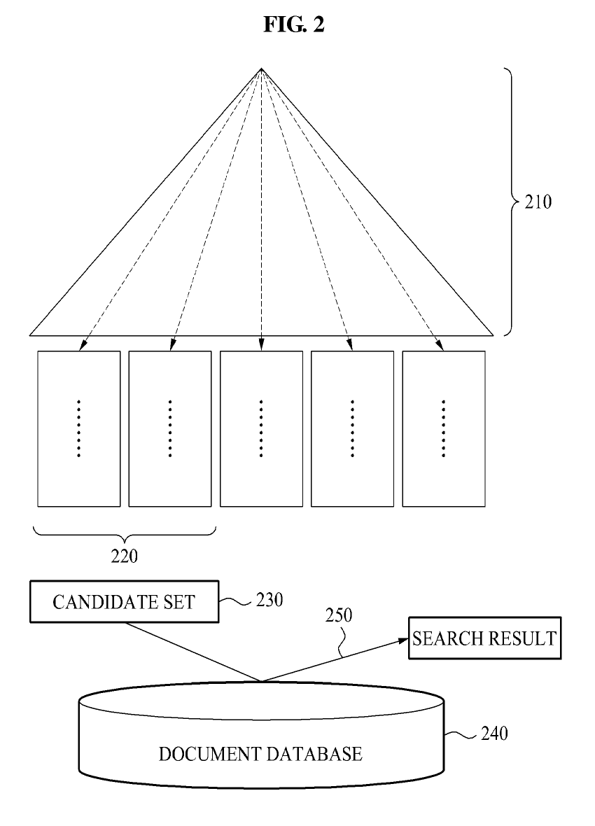

FIG. 2 illustrates an example of a fundamental principle.

As shown in FIG. 2, the fundamental principle uses a portion of the n-grams out of all of the n-grams constituting a search key. As described herein, a portion includes one or more n-grams. The portion does not include all of the n-grams of a search key. In this example, the fundamental principle is extracting a candidate set 230 of documents from a posting list 220 with respect to the portion of n-grams, and performing a filtering that compares the search key with an actual document stored in a document data base 240.

The cost expended for searching the posting list 220 may be substantially reduced because only a portion of the n-grams from all the n-grams constituting the search key are used. Because the search result of the searching of the posting list based on the portion of n-grams includes a larger number of results than a search result of searching of the posting list based on all the n-grams, a filter may be used to remove incorrect or unwanted search results.

For example, when an n-gram is a 2-gram and a search key is ‘SUNG’, the search key ‘SUNG’ may be constituted by three n-grams, such as ‘SU’, ‘UN’, and ‘NG’.

When a search is performed with respect to the three n-grams, a document including the ‘SUNG’ is accurately retrieved. However, when only a portion of the n-grams are used, the search result is not completely accurate. For example, when the search is performed using only two n-grams, such as ‘SU’ and ‘UN’, only up to ‘SUN’ may be accurately retrieved. One or more documents including ‘SUNY’ and ‘SUNE’ in addition to one or more documents including ‘SUNG’ are retrieved, which are inaccurate results.

A query process may be constituted by a process of extracting a candidate set from an n-gram index and a process of refinement or filtering. Accordingly, a cost model equation for selecting the n-gram subset may be constituted by a cost expended for extracting the candidate set and a refinement cost.

An example of a cost model equation for searching a document for a search key using an n-gram index is illustrated in Equation 1.

$$Cost ( Q ) = {\sum }_{{q}_{i} ∈ {Q}^{′}} ( h - 1 + {l}_{i} ) + refinement ( {Q}^{′} ) \qquad [ Equation 1 ]$$

For example, parameters of Equation 1 may be illustrated as shown below in Table 1.

TABLE 1

Q: a set of n-grams (Q = { q₁, q₂ , ..., qₙ})
qₙ: n^{th} n-gram constituting Q
SQ: sequentially arranged qᵢ constituting Q based on a size of lᵢ (SQ = Q)
(i = 1, 2, ..., n)
Q′: a subset of Q (Q′ ⊂ Q)
Cost(Q): a number of pages accessed to search for a document including Q
h: height of B⁺ tree
refinement (Q′): a size of a candidate set with respect to Q′
lᵢ :a number of leaf nodes of B⁺ tree including a posting list with respect
to qᵢ

Referring to Equation 1, the query processing cost may be constituted by a first cost expended for extracting a candidate set and a second cost expended for determining one or more documents that include the search key. For example, the second cost may be a cost expended for performing a refinement process with respect to the search key.

Referring to Equation 1, the first cost is determined based on “h−1.” In this example, the first cost is a cost expended for searching from a root node to a leaf node where an n-gram exists, and lᵢ is a number of all leaf nodes including n-grams.

When a number of positions where qᵢ exists is pᵢ, the cost expended for performing the refinement process with respect to the search key may be constituted by a number of pages including pᵢ among all pages. Accordingly, the term in a right side of Equation 1 may be expressed as illustrated in Equation 2.

$$refinement ( {Q}^{′} ) = \frac{L}{π} \cdot {\prod }_{{q}_{i} ∈ {Q}^{′}} \frac{{p}_{i}}{L} = \frac{L}{π} \cdot {\prod }_{{q}_{i} ∈ {Q}^{′}} \frac{m \cdot {l}_{i}}{L} \qquad [ Equation 2 ]$$

For example, parameters of Equation 2 may be illustrated as shown in Table 2.

TABLE 2

π: a mean of a number of positions existing in a document
m: a mean of a number of positions existing in a page

Based on Equation 2, Equation 1 may be modulated as illustrated in Equation 3.

$$\begin{matrix}Cost ( {Q}^{′} ) = {\sum }_{{q}_{i} ∈ {Q}^{′}} ( h - 1 + {l}_{i} ) + refinement ( {Q}^{′} ) \\ = {\sum }_{{q}_{i} ∈ {Q}^{′}} ( h - 1 + {l}_{i} ) + \frac{L}{π} \cdot {\prod }_{{g}_{i} ∈ {Q}^{′}} \frac{{p}_{i}}{L} \\ = {\sum }_{{q}_{i} ∈ {Q}^{′}} ( h - 1 + {l}_{i} ) + \frac{L}{π} \cdot {\prod }_{{g}_{i} ∈ {Q}^{′}} \frac{m \cdot {l}_{i}}{L}\end{matrix} \qquad [ Equation 3 ]$$

Referring to Equation 3, a first term is proportional to a sum of 1ᵢ and a second terminal is proportional to a multiplication of 1ᵢ. Accordingly, the query processing cost may be at a minimum, when both i, and 1ᵢ are at a minimum.

When a cost model equation for calculating the query processing cost is in a convex-typed variation curve according to an n-gram subset, an n-gram subset expending a minimum query processing cost exists.

The cost model for calculating the query processing cost may be as illustrated in Equation 4.

$${c}_{k} = {a}_{k} + {b}_{k} , \\ {a}_{k} = {\sum }_{{q}_{i} ∈ {Q}_{k}} ( h - 1 + {l}_{i} ) = {\sum }_{{q}_{i} ∈ {SQ}_{k}} ( h - 1 + {l}_{i} ) \\ {b}_{k} = \frac{L}{π} \cdot {\prod }_{{g}_{i} ∈ {Q}_{k}} \frac{m \cdot {l}_{i}}{L} = \frac{L}{π} \cdot {\prod }_{{g}_{i} ∈ {SQ}_{k}} \frac{m \cdot {l}_{i}}{L} , \qquad [ Equation 4 ]$$

Referring to Equation 4, when a number of n-gram subsets is n, k may have a value of 1 through n. In this example, aₖ increases as k increases. Also, bₖ decreases as the k increases. The query processing cost cₖ is more affected by bₖ as k decreases, and is more affected by aₖ as k increases. Accordingly, cₖ may be in the convex-typed variation curve. Also, a k of when the cₖ is at a minimum is an n-gram subset that expends a minimum cost to search for the search key.

A method of searching for a k of when the query processing cost is at a minimum may be a linear search or a binary search. When the number of subsets of the n-gram is n, a minimum value of the cₖ may be obtained by calculating the cₖ by changing k from 1 through n. According to a linear search, since the cₖ is in a form of convex, the cₖ decreases and then increases again, as the k increases. Accordingly, when Q={qₖ|1<k<n}, i=k+1, a k value where cₖ<cᵢ is a k value where a search cost is at a minimum. Also, the minimum value of the cₖ may be obtained by substituting the k based on the binary search.

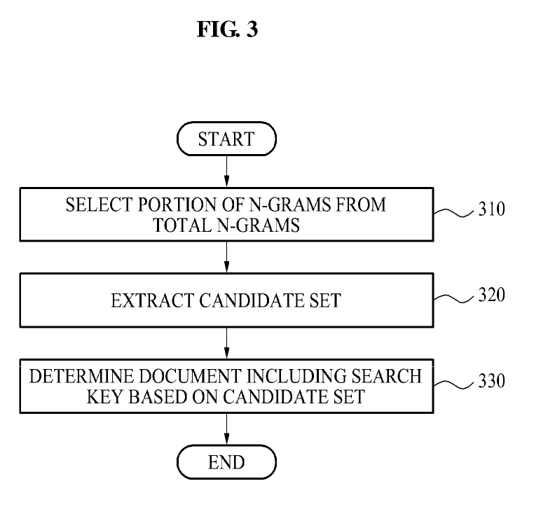

FIG. 3 illustrates an example of a query processing method.

The query processing method of FIG. 3 may be performed by a query processing apparatus including a query processing processor.

As shown in FIG. 3, in 310, the query processing apparatus may select a portion of the n-grams from all n-grams with respect to a search key, based on a query processing cost.

For example, the query processing cost may be determined based on a number of accesses to pages of a document, during a query processing procedure. The query processing cost may use, as an example, the method described in Equation 1, which is an example of a cost model equation for selecting n-gram subset. For example, the query processing cost may be determined based on a cost expended for extracting a candidate set and a cost expended for determining a document including the search key based on the candidate set. The cost expended for extracting a candidate set may be determined based on a cost expended for searching from a root node to a leaf node, including an n-gram, and the number of all leaf nodes including n-grams. The cost expended for determining the document including the search key may be based on a number of pages including n-grams from among all the pages constituting the document.

The selected portion of n-grams may be an n-gram subset. A method for selecting the n-gram subset may be the method described in Equation 4, which is an example of selecting of an n-gram subset having a minimum cost.

In 320, the query processing apparatus may extract the candidate set of documents having a possibility of including the search key, based on a posting list with respect to the portion of n-grams.

In 330, the query processing apparatus may determine a document including the search key based on the candidate set. The query processing apparatus may compare an actual document corresponding to the candidate set with the search key, and may select document identification information of the document including the search key from the candidate set. For example, in 330, the query processing apparatus may perform filtering by comparing the actual document with the search key.

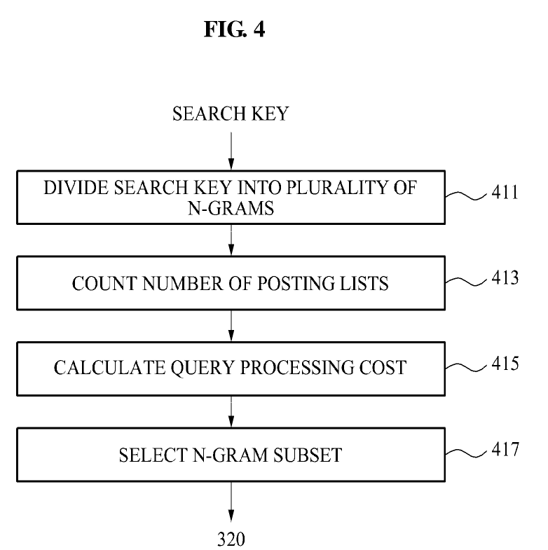

FIG. 4 illustrates an example of an n-gram subset selecting method and is applicable to operation 310 of FIG. 3. Accordingly, the method described with reference to FIG. 4 may be performed by a query processing apparatus including a query processing processor.

Referring to FIG. 4, in 411, the query processing apparatus may divide a search key into a plurality of n-grams, for example, two n-grams, three n-grams, four n-grams, five n-grams, or other desired amount of n-grams.

In 413, the query processing apparatus may determine a number of posting lists for each of a plurality of n-grams. For example, the number of the posting lists of each of the plurality of n-grams may be a predetermined value.

In 415, the query processing apparatus may calculate a query processing cost of each of the plurality of n-grams. For example, the query processing cost may use a cost model equation for selecting an n-gram subset.

In 417, the query processing apparatus may select an n-gram subset that expends a minimum query processing cost. The n-gram subset expending the minimum query processing cost may be defined from an n-gram having a smallest number of posting lists or an n-gram requiring minimum query processing cost. The n-gram subset expending the minimum query processing cost may be calculated based on, for example, the method described for selecting an n-gram subset having a minimum cost.

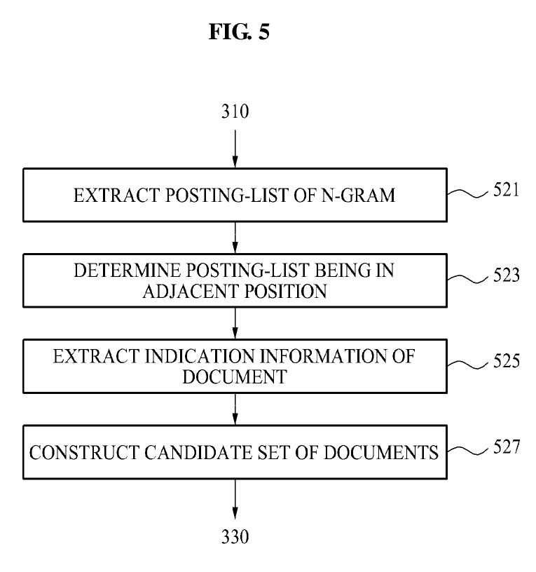

FIG. 5 illustrates an example of a candidate set selecting method, and is applicable to operation 320 of FIG. 3. Accordingly, the method may be performed by a query processing apparatus including a query processing processor.

Referring to FIG. 5, in 521, the query processing apparatus may extract a posting list of n-grams constituting an n-gram subset.

In 523, the query processing apparatus may determine posts located in adjacent positions from the posting lists extracted in 521.

In 525, the query processing apparatus may extract document identification information from the posts located in adjacent positions.

In 527, the query processing apparatus may construct a candidate set based on the extracted document identification information.

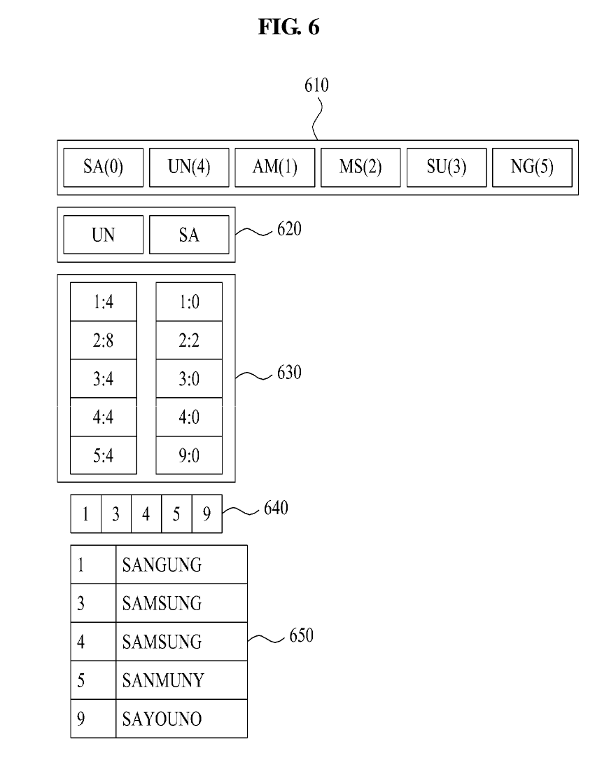

FIG. 6 illustrates an example of a candidate set selecting method.

In FIG. 6, the n-gram is a 2-gram and the search key is “SAMSUNG.” For example, the query processing processor allows a plurality of n-grams 610 to be divided into six n-grams. For example, the search key may be broken into 2-grams with position information such that “SA,” is 0, “AM” is 1, “MS” is 2, “SU” is 3, “UN” is 4, and “NG” is 5. The number in the n-grams may represent the location of the subset to the entire search key.

In this example, the n-gram subset 620 is constituted by “UN” and “SA”. The n-gram subset allows the query processing processor to effectively choose a portion of n-grams. The “UN” n-gram is the 4^{th} position subset from the entire search key, and “SA” n-gram is the 0^{th} position from the entire search key.

The posting list 630, corresponding to the n-gram subset 620, is expressed in a form of [document ID: position information].

In the posting list 630, a search result is document ID 1, 3, 4, 5, and 9. The positions of [2:8] and [2:2] are not adjacent. Because the “SA” and “UN” may obtain a valid result only when a position information difference is less than four, a document of which document ID is 2 may not be the candidate set.

Thus, in some examples, documents corresponding to document ID 1, 5, and 9 do not include the search key “SAMSUNG” among actual documents 640 corresponding to a candidate set 650. Accordingly, the documents corresponding to the document ID 1, 5, and 9 may be removed during filtering.

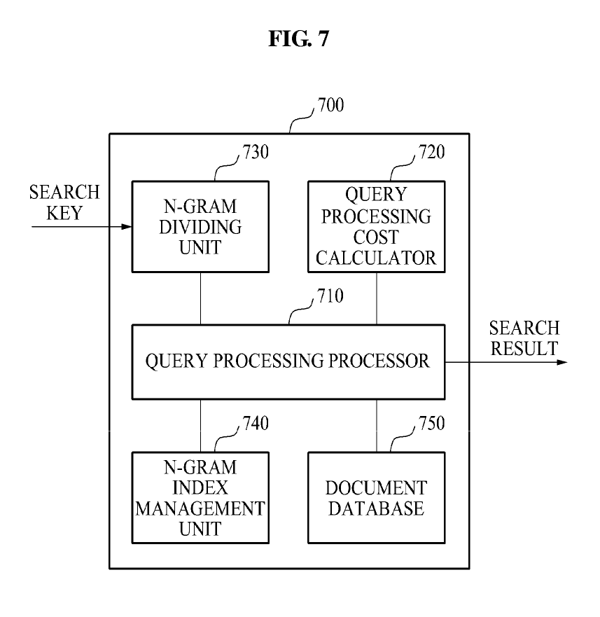

FIG. 7 illustrates an example of a query processing apparatus.

As shown in FIG. 7, the query processing apparatus 700 may perform methods based on the examples described herein. The query processing apparatus 700 may perform methods based on controlling of a query processing processor 710. For example, the query processor may select a portion of n-grams from all n-grams with respect to a search key, extract a candidate set of documents having a possibility of including the search key, based on a posting list with respect to the portion of n-grams, and determine a document including the search key based on the candidate set.

Referring to FIG. 7, the example query processing apparatus 700 includes the query processing processor 710, a query processing cost calculator 720, an n-gram dividing unit 730, an n-gram index management unit 740, and a document database 750.

The query processing cost calculator 720 may calculate a query processing cost. Accordingly, the query processing cost calculator 720 may calculate the query processing cost based on a cost expended for extracting the candidate set and a cost expended for determining a document including the search key based on the candidate set.

The n-gram dividing unit 730 may divide the search key into a plurality of n-grams.

The n-gram index management unit 740 may store and manage an n-gram index for processing the search key.

The document database 750 may store the document including the search key.

Accordingly, a query processing may be efficiently performed even when a length of a search key is long.

Also, the query processing apparatus does not change a configuration of an n-gram index and may improve a query processing performance, thereby being applicable to a conventional search service sector without an overhead that changes the configuration of the n-gram index.

The processes, functions, methods and/or software described above may be recorded in computer-readable storage media that includes program instructions to be implemented by a computer to cause a processor to execute or perform the program instructions. The media may also include, alone or in combination with the program instructions, data files, data structures, and the like. The media and program instructions may be those specially designed and constructed, or they may be of the kind well-known and available to those having skill in the computer software arts. Examples of computer-readable storage media include magnetic media such as hard disks, floppy disks, and magnetic tape; optical media such as CD ROM disks and DVDs; magneto-optical media such as optical disks; and hardware devices that are specially configured to store and perform program instructions, such as read-only memory (ROM), random access memory (RAM), flash memory, and the like. Examples of program instructions include machine code, such as produced by a compiler, and files containing higher level code that may be executed by the computer using an interpreter. The described hardware devices may be configured to act as one or more software modules in order to perform the operations and methods described above, or vice versa. In addition, a computer-readable storage medium may be distributed among computer systems connected through a network and computer-readable codes or program instructions may be stored and executed in a decentralized manner.

A computing system or a computer may include a microprocessor that is electrically connected with a bus, a user interface, and a memory controller. It may further include a flash memory device. The flash memory device may store N-bit data via the memory controller. The N-bit data is processed or will be processed by the microprocessor and N may be 1 or an integer greater than 1. Where the computing system or computer is a mobile apparatus, a battery may be additionally provided to supply operation voltage of the computing system or computer.

It will be apparent to those of ordinary skill in the art that the computing system or computer may further include an application chipset, a camera image processor (CIS), a mobile Dynamic Random Access Memory (DRAM), and the like. The memory controller and the flash memory device may constitute a solid state drive/disk (SSD) that uses a non-volatile memory to store data.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A method of processing a search key, the method comprising:
selecting a portion of n-grams from all n-grams with respect to the search key, based on a query processing cost;
extracting a candidate set of documents having a possibility of including the search key, based on a posting list with respect to the portion of n-grams; and
determining a document where the search key exists, based on the candidate set.

2. The method of claim 1, wherein the query processing cost is determined based on a number of accesses that occur to pages of the document, during a query processing procedure.

3. The method of claim 1, wherein the query processing cost is determined based on a cost expended for extracting the candidate set and a cost expended for determining the document including the search key, based on the candidate set.

4. The method of claim 3, wherein the cost expended for extracting the candidate set is determined based on a cost expended for searching from a root node to a leaf node including an n-gram, and based on a number of all leaf nodes including n-grams.

5. The method of claim 3, wherein the cost expended for determining the document is determined based on a number of pages including n-grams among all pages constituting the document.

6. The method of claim 1, wherein the selecting of the portion of n-grams comprises:
dividing the search key into a plurality of n-grams;
counting a number of posting lists with respect to each of the plurality of n-grams;
calculating a query processing cost with respect to each of the plurality of n-grams; and
selecting an n-gram subset that has a minimum query processing cost.

7. The method of claim 6, wherein the selecting of the n-gram subset is determined based on an n-gram that has a smallest number of posting-lists and an n-gram that expends a minimum query processing cost.

8. The method of claim 1, wherein the extracting of the candidate set comprises:
extracting a posting list of n-grams constituting the portion of n-grams;
determining posts located in adjacent positions based on the extracted posting list;
extracting document identification information of the documents from the posts located in adjacent positions; and
constructing the candidate set based on the extracted document identification information of the documents.

9. The method of claim 1, wherein the determining of the document where the search key exists comprises:
comparing the search key with an actual document corresponding to the candidate set; and
selecting document identification information of the document where the search key exists, from among the candidate set.

10. A computer readable storage medium storing one or more executable instructions to cause a processor to perform a method comprising:
selecting a portion of n-grams from all n-grams with respect to the search key, based on a query processing cost;
extracting a candidate set of documents having a possibility of including the search key, based on a posting list with respect to the portion of n-grams; and
determining a document where the search key exists, based on the candidate set.

11. An apparatus for processing a search key based on controlling of a query processing processor, wherein the query processing processor performs:
selecting of a portion of n-grams from all n-grams with respect to the search key, based on a query processing cost;
extracting of a candidate set of documents having a possibility of including the search key, based on a posting list with respect to the portion of n-grams; and
determining of a document where the search key exists based on the candidate set.

12. The apparatus of claim 11, further comprising:
a query processing cost calculator to calculate the query processing cost based on a cost expended for extracting the candidate set and a cost expended for determining the document where the search key exists, based on the candidate set.

13. The apparatus of claim 12, wherein the cost expended for extracting the candidate set is determined based on a cost expended for searching from a root node to a leaf node including an n-gram, and based on a number of all leaf nodes including n-grams.

14. The apparatus of claim 12, wherein the cost expended for determining the document is determined based on a number of pages including n-grams among all pages constituting the document.

15. The apparatus of claim 11, wherein an n-gram subset having a minimum query processing cost is determined as the portion of n-grams.

16. The apparatus of claim 11, further comprising:
an n-gram index management unit to store and manage an n-gram index to process the search key; and
a document database to store the document including the search key.
